(19) United States
(12) Patent Application Publication
(10) Pub. No.: US 2026/0228676 A1
(43) Pub. Date: Aug. 6, 2026

(54) MATERIALS TRACKER WITH PEEL-OFF-ACTIVATED CIRCUITRY FOR SHIPMENT AND ADMINISTRATION MONITORING

(71) Applicant: ETHERWHERE CORPORATION, Sunnyvale, CA (US)

(72) Inventor: Farrokh FARROKHI, San Ramon, CA (US)

(21) Appl. No.: 19/531,515

(22) Filed: Feb. 5, 2026

Related U.S. Application Data
(60) Provisional application No. 63/754,465, filed on Feb. 5, 2025.

(51) Int. Cl. G06Q 10/0833; H04W 4/02

(52) U.S. Cl. CPC G06Q 10/0833; H04W 4/027

(57) ABSTRACT

A materials tracker includes a housing having an adhesive base configured for attachment to a package, a flexible printed circuit board disposed within the housing, and a battery configured to power the flexible printed circuit board. The materials tracker includes a non-stick peel-off layer covering the adhesive base, wherein removal of the peel-off layer activates the battery by breaking an electrical connection that maintains the battery in a deactivated state during storage. The materials tracker includes location tracking circuitry configured to record location data and timing data.

### CROSS-REFERENCE TO RELATED APPLICATIONS

This application claims the benefit of U.S. Provisional Application No. 63/754,465, filed Feb. 5, 2025, the contents of which are incorporated by reference herein.

### TECHNICAL FIELD

The present disclosure relates to tracking devices for monitoring materials during shipment and handling, and more particularly to a low-cost, disposable tracker with peel-off-activated circuitry for recording location and timing data of packages from shipment through administration.

### BACKGROUND

The tracking and monitoring of materials during shipment and handling presents various challenges across multiple industries. In particular, the transportation of time-sensitive materials, such as radioactive substances used in medical applications, requires careful documentation of timing and location data throughout the supply chain. Radioactive materials, including isotopes used for diagnostic imaging and therapeutic treatments, have limited useful lifespans due to radioactive decay, making accurate tracking of harvest time, transit duration, and administration time essential for proper utilization.

Conventional tracking systems often employ reusable electronic devices that can be expensive and may require manual activation or user intervention to record timing events. Such systems may also rely on button presses or other deliberate user actions to mark transitions between different stages of the shipment and handling process. These requirements can introduce opportunities for human error or inconsistent data recording, particularly in busy clinical or laboratory environments where personnel may be focused on other tasks.

Additionally, existing tracking solutions may consume battery power during storage periods before deployment, potentially reducing their operational lifespan when actually in use. The cost of sophisticated tracking devices can also be prohibitive for single-use applications, leading to compromises in tracking coverage or the need for device recovery and refurbishment programs that add logistical complexity.

The physical design of tracking devices presents further considerations. Devices that attach to packages or containers benefit from secure adhesion during transit while also allowing for detection of package opening or material removal events. Balancing these competing requirements of secure attachment and event detection can be challenging with conventional device architectures.

Accordingly, there exists a general interest in tracking solutions that address considerations related to cost, ease of use, automatic event detection, and power management for applications involving the shipment and handling of materials where timing and location documentation are beneficial.

### SUMMARY

In accordance with an aspect of the disclosure, a materials tracker is provided that includes: an adhesive base configured for attachment to a package; a flexible printed circuit board disposed adjacent the adhesive base and including location tracking circuitry; a battery configured to power the flexible printed circuit board; and a non-stick cover covering the adhesive base, wherein removal of the non-stick cover activates the location tracking circuitry by breaking an electrical connection that maintains the location tracking circuitry in a deactivated state during storage, and wherein the location tracking circuitry is configured to record a location of the materials tracker and a time upon the breaking of the electrical connection.

In accordance with another aspect of the disclosure, a method is provided that includes: providing a materials tracker having an adhesive base covered by a peel-off layer, a flexible printed circuit board, a battery, and location tracking circuitry; removing the peel-off layer from the materials tracker, wherein removal of the peel-off layer activates the battery to power the location tracking circuitry by breaking an electrical connection; attaching the materials tracker to a package via the adhesive base; recording, by the location tracking circuitry, a first location of the package in response to the attachment of the materials tracker to the package; recording, by the location tracking circuitry, a second location of the package in response to a delivery of the package to a delivery address; removing the materials tracker from the package, wherein removal causes a metal element to remain adhered to the package and break a connection between a pair of terminals; and recording an administration time in response to a breaking of the connection between the pair of terminals.

In accordance with another aspect of the disclosure, a circuit activation mechanism for a tracking device is provided that includes: a power management unit having an enable pin, wherein the power management unit is coupled between a battery and a location tracking circuit; a removable conductive element connecting the enable pin to the battery to maintain the power management unit in an operational state; and an adhesive layer mechanically coupled to the removable conductive element, wherein physical removal of the adhesive layer from a package disconnects the removable conductive element from the enable pin to transition the power management unit to a non-operational state

These and other advantageous features may be better appreciated through the following detailed description.

### BRIEF DESCRIPTION OF THE DRAWINGS

FIG. 1 is a block diagram of a materials tracker in accordance with an aspect of the disclosure.

FIG. 2A is a plan view of a materials tracker including a frangible wire configured to tear upon removal of a non-stick cover that covers an adhesive layer to switch on the material tracker in accordance with an aspect of the disclosure.

FIG. 2B illustrates a pair of metal terminals coupled together through a frangible connection that is configured to tear upon removal of the adhesive layer from a package to switch off the tracker in accordance with an aspect of the disclosure.

FIG. 2C illustrates the pair of metal terminals of FIG. 2B after removal of the frangible connection.

FIG. 2D illustrates a mask for masking the frangible connection from glue.

FIG. 3A illustrates the materials tracker of FIGS. 2A and 2B before peel off, after peel off, and after adhesion to a package.

FIG. 3B illustrates the material tracker of FIGS. 2A and 2B after peel off of the tracker from a package upon delivery.

FIG. 4 illustrates an example PMOS transistor switch that is switched on upon removal of a frangible wire to activate the materials tracker upon adhesion to a package.

FIG. 5 illustrates a PMU that is switched off upon removal of the materials tracker from the package after delivery to switch off the materials tracker.

FIG. 6 illustrates a materials tracker including a conductive tape that a user tears off to activate the materials tracker in accordance with an aspect of the disclosure.

FIG. 7 illustrates the materials tracker of FIG. 6 before peel off, after peel off, and after sticking to a package.

Implementations of the present disclosure and their advantages are best understood by referring to the detailed description that follows. It should be appreciated that like reference numerals are used to identify like elements illustrated in one or more of the figures.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

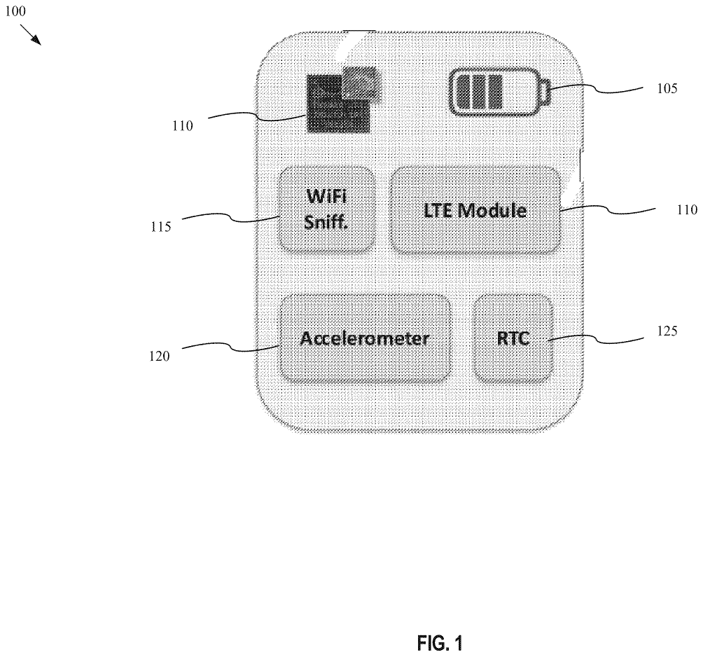

The present disclosure relates to a materials tracker configured for tracking materials during shipment and handling. The following discussion will be directed to an application in which tracked shipment included a radioactive device such as radioactive isotopes for medical device applications, but it will be appreciated that the materials tracker disclosed herein is applicable to any suitable tracking application. An example materials tracker 100 is shown in FIG. 1. A battery 105 provides power to a variety of components such as a global navigation satellite system (GNSS) (e.g., a GPS) tracker 110. In addition, a WiFi module 115 also receives power so that WiFi beacons may be sampled (sniffed). In this fashion, should the tracker 100 be indoors such that the GNSS tracker 110 does not have a sufficiently strong satellite signal, the WiFI module may sniff (detect) WiFI beacons such that the location may be triangulated from the WiFI beacon locations. Similarly, the battery 105 powers an LTE module 110 so that a location and status of the materials tracker 100 may be updated. To detect movement, the tracker 100 may also include an accelerometer 120. Finally, a real time clock (RTC) 125 may track the time during operation of the tracker 100. The materials tracker 100 may be a low-cost, disposable device suitable for single-use applications. In some cases, the materials tracker 100 is designed to be affixed to a package containing radioactive materials and to accompany the package throughout a shipment and handling lifecycle.

The materials tracker 100 may be configured to record multiple time events throughout a material lifecycle. In some cases, the materials tracker 100 records a harvest time corresponding to when radioactive materials are harvested or prepared. The materials tracker 100 may also record a reception time corresponding to when the radioactive materials arrive at a receiving location. In some cases, the materials tracker 100 further records an administration time corresponding to when the radioactive materials are administered to a patient or otherwise utilized. The recording of these multiple time events may allow for comprehensive tracking of radioactive materials from preparation through final use.

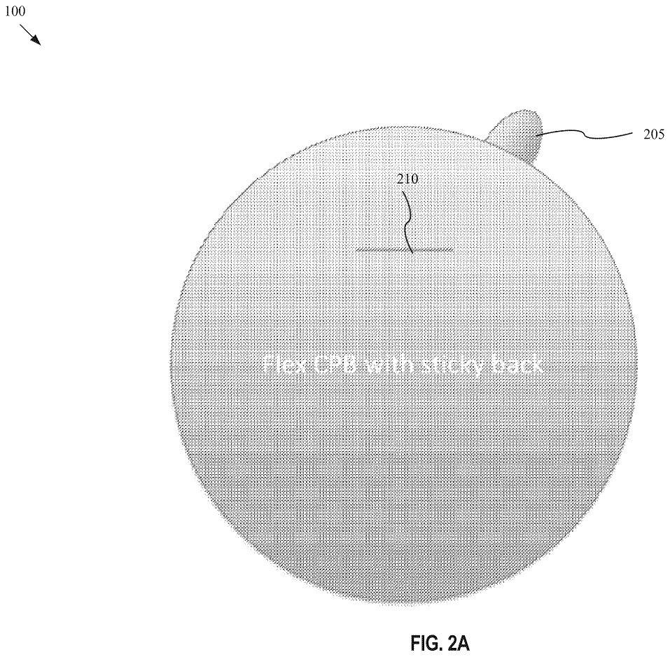

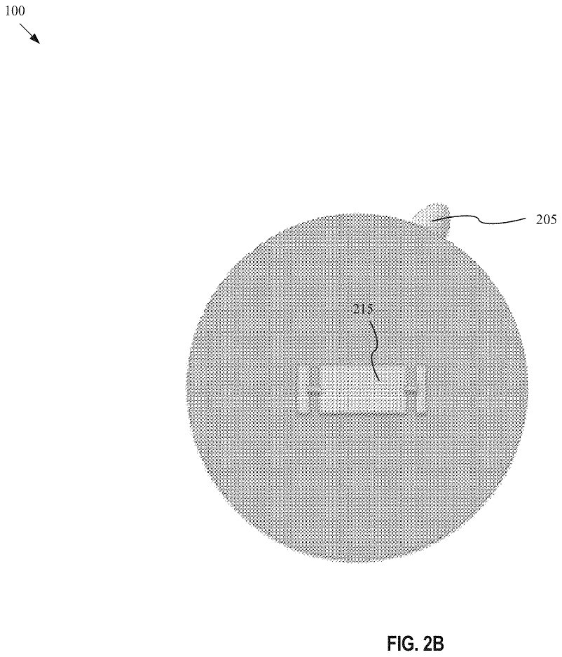

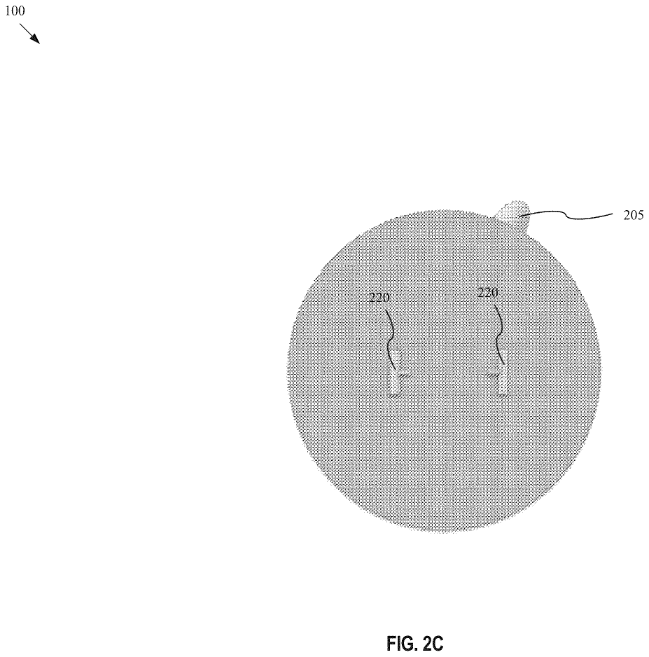

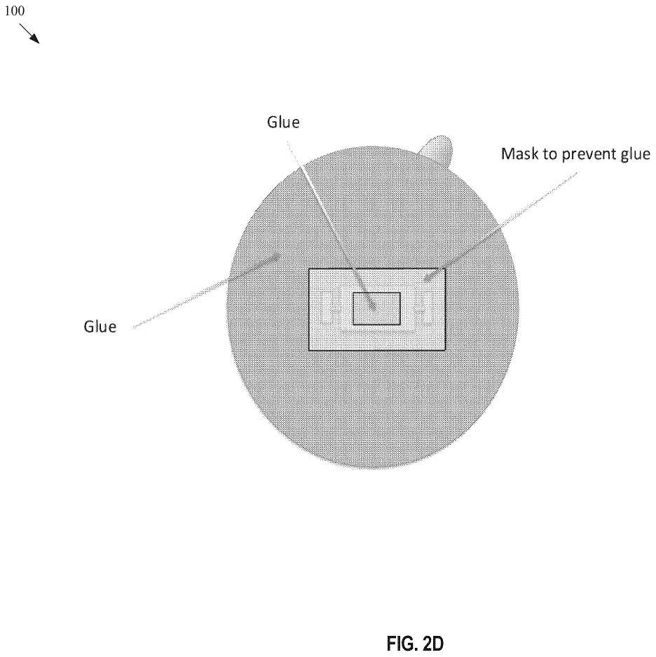

As shown in a plan view of FIG. 2A and in a backside view of FIG. 2B, the materials tracker 100 may have a flattened disc-shaped form factor configured for attachment to packages containing radioactive materials. In some cases, the materials tracker 100 includes a sticky or adhesive base protected by a non-stick cover. To aid in removal of the non-stick cover, an ear 205 may project from the cover. By peeling the cover using the ear 205, a user may expose the adhesive back. To activate or turn on the tracker, the sticky back may include a frangible wire 210 that adheres to the cover such that the wire 210 is torn during removal of the cover. As will be discussed further herein, this tearing of the frangible wire 210 switches on the tracker 100 so that it may record a beginning shipment address and time (T1). The tracker 100 may then use the GNSS receiver 110 and RTC 124 to determine a real time location and time every few minutes or when movement is detected such as through the accelerometer 120. Alternatively, the WiFi sniffer 115 may triangulate a position of the tracker 100 by detecting WiFi beacons having known positions. This recording of the time and position after activation may be programmable or set to some pre-determined schedule. In addition, once activated the accelerometer 120 may detect motion of the tracker to trigger a recording of the tracker 100 location and time.

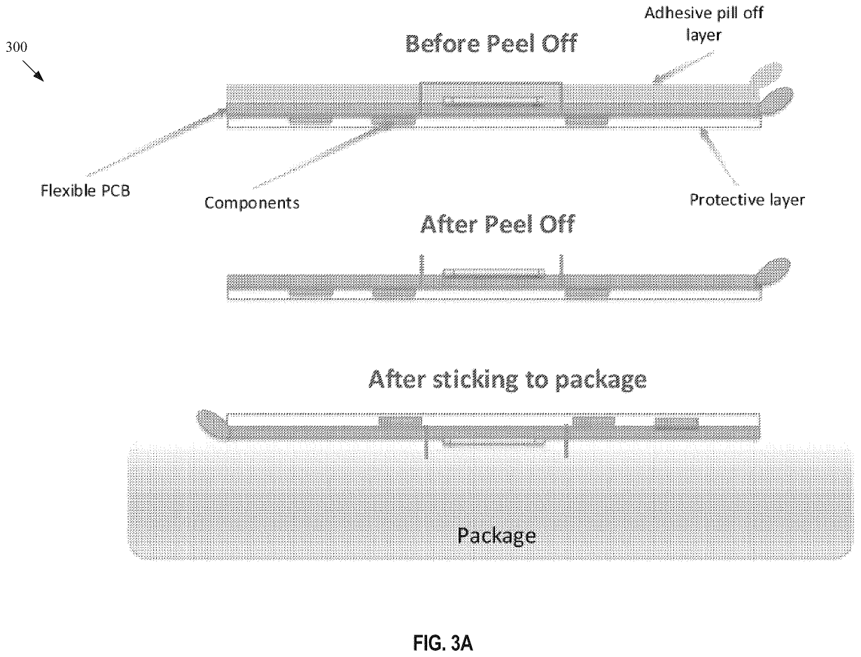

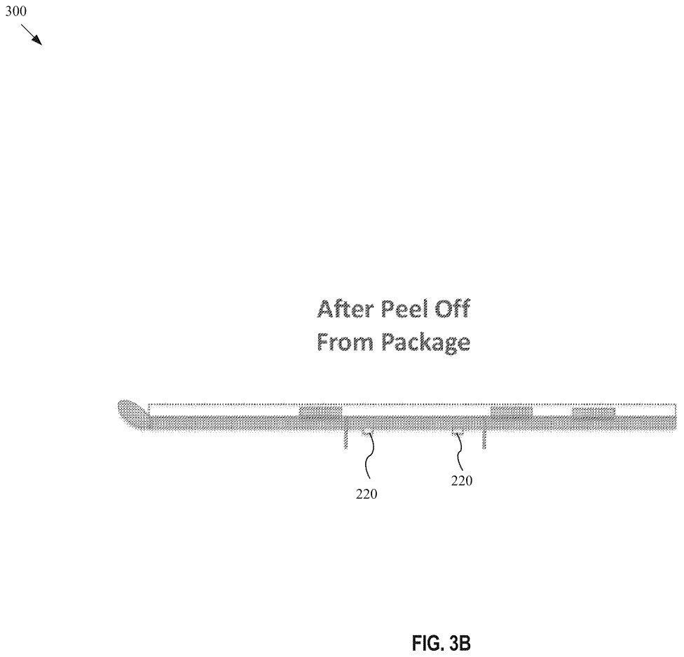

The materials tracker 100 may include a layered structure as shown in FIG. 3A comprising multiple distinct components. In some cases, the layered structure includes a non-stick peel-off layer as a separate component. The non-stick peel-off layer exposes an adhesive layer to attach the materials tracker 100 to a package surface. The layered structure may further include a flexible printed circuit board to couple to the electric modules which in turn may be cushioned by a foam protective layer. The foam protective layer may be positioned to shield underlying components of the materials tracker from environmental exposure or physical damage during handling and shipment.

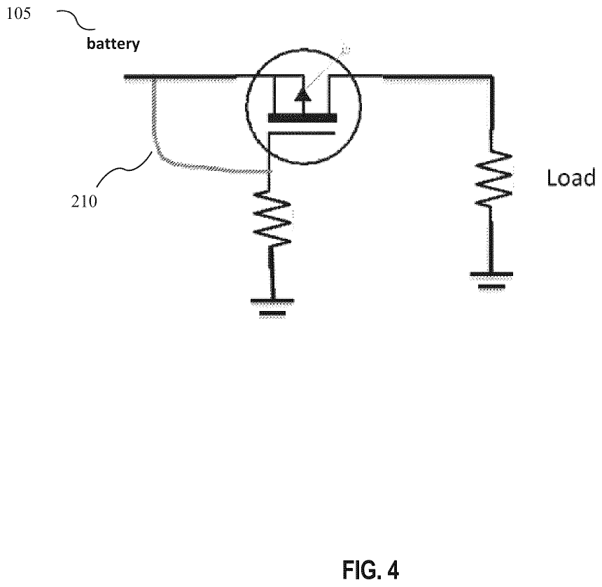

The frangible wire 210 that breaks upon removal of the cover may be arranged as shown in FIG. 4. In this implementation, the wire 210 couples between the drain and gate of a PMOS transistor that couples between the battery 105 and the load (the modules to be powered such as discussed with respect to FIG. 1). Prior to being broken, the wire 210 keeps the gate of the PMOS transistor charged to keep the PMOS transistor off. But when broken, the gate of the PMOS transistor is grounded to switch on the PMOS transistors so that the materials tracker 100 is switched on and may begin recording a position and time. The resulting battery activation mechanism may prevent battery drain when the materials tracker 100 is sitting on a shelf for extended periods prior to use. In some cases, the battery 105 remains in an inactive state while the cover is in place, and transitions to an active state upon removal of the cover during attachment of the materials tracker 100 to the package. The wire 210 may be positioned such that peeling the cover from the materials tracker 100 breaks the wire 210, thereby turning the materials tracker 100 on. In some cases, the wire 210 is integrated into an adhesive layer or peel-off component of the materials tracker 100 such that separation of the adhesive layer or peel-off component during attachment to a package causes removal of the wire 210 and activation of the materials tracker 100.

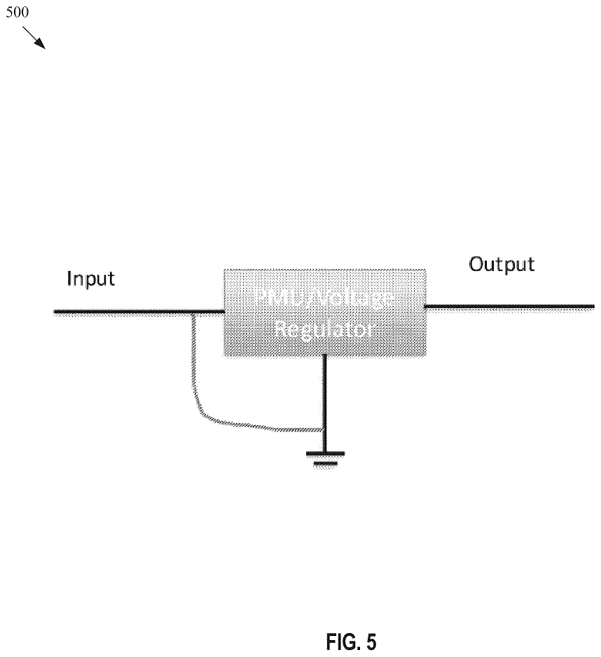

The materials tracker 100 may detect that it is within some threshold distance (e.g., 50 meters) of the receiving address with no further movement to determine that the package has been delivered. Following delivery, a user may remove the materials tracker 100 to open the package. Referring again to FIG. 2B, the adhesive layer may cover a frangible electrode 215 that tears as shown in FIG. 2C upon opening of the package and removal of the materials tracker 100. In that regard, the package may be sealed with the materials tracker 100 such that a user will peel off the materials tracker 100 to open the package. The resulting tearing of the electrode 215 isolates terminals 220 from each other. For example, the materials tracker 100 may include power management unit or voltage regulator as shown in FIG. 5 that includes an enable pin connected to the battery input. When electrode 215 is torn, the enable pin is no longer connected to power and causes the power management unit to power down the materials tracker 100. The materials tracker 100 may record a final administration time upon removal of the materials tracker 100 from the package. The wire-based activation mechanism may allow for selective control of power states within the materials tracker 100 based on physical manipulation of the electrode 215 during attachment or removal operations.

The materials tracker 100 may use the GNSS tracker 110 and/or the WiFi sniffer 115 to provide real-time location data and time data along a delivery route. In some cases, the location tracking circuitry transmits location data and time data at regular intervals, such as every few minutes, during transit of the package. The location tracking circuitry may also be configured to transmit location data and time data when triggered by specific events. In some cases, the specific events that trigger transmission of location data and time data include changes in motion state, changes in orientation, or detection of environmental conditions such as temperature thresholds. The location tracking circuitry may utilize global positioning system (GPS) technology, cellular network triangulation, or other positioning technologies to determine the real-time location of the materials tracker 100 during shipment. The LTE module 110 may then upload the various recorded locations, times, and other data from the tracker to a server (not illustrated) such as in the cloud.

The materials tracker 100 may include a proximity-based arrival detection system configured to detect when the materials tracker 100 has arrived at a receiving location. In some cases, the proximity-based arrival detection system is configured to determine when the materials tracker 100 is within a predetermined distance of a receiving address. The predetermined distance may be approximately 50 meters, though other distance thresholds may be utilized depending on application requirements. The receiving address may be stored in a database accessible to the materials tracker 100 or to an analytics system in communication with the materials tracker 100. In some cases, the proximity-based arrival detection system compares the real-time location data from the location tracking circuitry to the receiving address stored in the database to determine proximity to the receiving location.

The proximity-based arrival detection system may be further configured to detect when the location of the materials tracker 100 is not changing. In some cases, the proximity-based arrival detection system monitors location data over a period of time to determine whether the materials tracker 100 has become stationary. When the materials tracker 100 is within the predetermined distance of the receiving address and the location of the materials tracker 100 is not changing, the proximity-based arrival detection system may determine that the materials tracker 100 has arrived at the receiving location. In some cases, an analytics system records a time of receiving when the proximity-based arrival detection system determines that the materials tracker 100 is within the predetermined distance of the receiving address and the location is not changing. The time of receiving may correspond to a reception time event in the material lifecycle tracking performed by the materials tracker 100.

The materials tracker 100 may include a button-free administration detection mechanism configured to record an administration time without requiring user interaction with a button. In some cases, the button-free administration detection mechanism is configured such that when the materials tracker 100 is removed from the package in order to open the package, the materials tracker 100 records the time of administration automatically. The button-free administration detection mechanism may eliminate the need for a user to press a button or otherwise manually input information to record the administration time event. In some cases, the physical act of removing the materials tracker 100 from the package to access the contents of the package serves as the trigger for recording the administration time such as through the tearing of the electrode 215 leaving the terminals 220 isolated from each other as shown in FIG. 3B.

The materials tracker 100 may be manufactured using a mask-based adhesive application process. In some cases, a mask is used during manufacturing as shown in FIG. 2D to apply glue to specific areas of the materials tracker 100. The mask may define adhesive regions on the flexible printed circuit board by selectively exposing portions of the flexible printed circuit board surface to adhesive material while shielding other portions from adhesive application. In some cases, the mask is positioned over the flexible printed circuit board prior to application of the glue, and the glue is applied over the mask such that the glue contacts the flexible printed circuit board through openings in the mask. The mask may then be removed, leaving adhesive material deposited in a pattern corresponding to the openings in the mask. In some cases, the mask-based adhesive application process allows for precise control over the location and extent of adhesive regions on the flexible printed circuit board, enabling selective adhesion characteristics in different areas of the materials tracker 100. The adhesive regions defined by the mask may correspond to areas where the materials tracker is intended to adhere to a package surface, while non-adhesive regions may correspond to areas where separation or removal is desired during operation of the materials tracker 100.

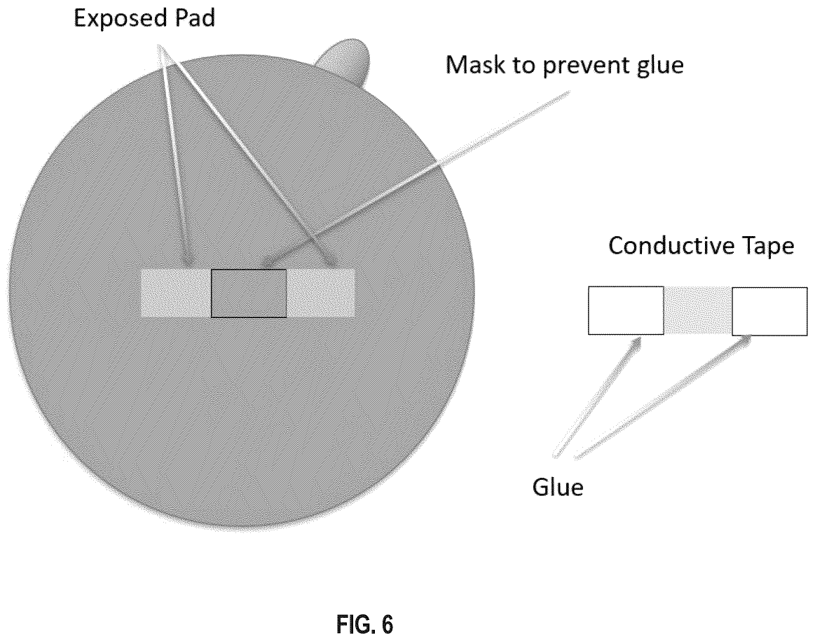

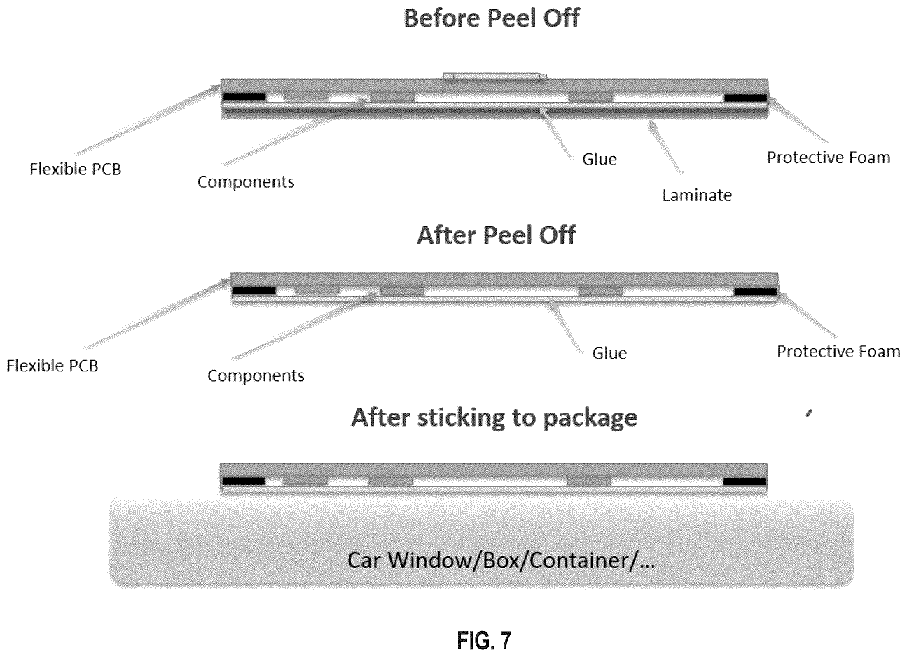

Rather than have incorporate a frangible wire 210 onto the glue layer, a top side of a materials tracker 600 may include a conductive tape that couples between two exposed pads as shown in FIG. 6 and also in cross-sectional view of FIG. 7. Upon installation of the tracker 600 onto a package, the user would tear off the conductive tape to isolate the two exposed pads and cause the tracker 600 to switch on analogously as discussed with respect to FIG. 4. As shown in FIG. 7, the conductive tape is removed from the upper surface of the tracker 600 along with the non-stick cover from the backside. The tracker 600 is then switched on and may be adhered to the package.

One advantage of the accelerometer 120 is that the tracker may be configured to record a location, time, and acceleration should the accelerometer 120 detect an acceleration of the package above a threshold level. In this fashion, the tracker may monitor whether a shipper has dropped or otherwise mishandled the package, a feature that is particularly useful for radioactive or other dangerous package payloads.

It will be appreciated that many modifications, substitutions and variations can be made in and to the materials, apparatus, configurations and methods of use of the devices of the present disclosure without departing from the scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A materials tracker, comprising:
an adhesive base configured for attachment to a package;
a flexible printed circuit board disposed adjacent the adhesive base and including location tracking circuitry;
a battery configured to power the flexible printed circuit board; and
a non-stick cover covering the adhesive base, wherein removal of the non-stick cover activates the location tracking circuitry by breaking an electrical connection that maintains the location tracking circuitry in a deactivated state during storage, and wherein the location tracking circuitry is configured to record a location of the materials tracker and a time upon the breaking of the electrical connection.

2. The materials tracker of claim 1, wherein the adhesive base includes a wire that connects to an enable pin of a power management unit coupled between the battery and the location tracking circuitry, wherein removal of the adhesive base from a package tears the wire to deactivate the power management unit.

3. The materials tracker of claim 1, further comprising a PMOS transistor having a source coupled to the battery and a drain coupled to the location tracking circuitry, wherein the electrical connection comprises a frangible wire coupled between the drain and a gate of the PMOS transistor.

4. The materials tracker of claim 1, wherein the location tracking circuitry is configured to record a shipment time when the non-stick cover is removed and the materials tracker is attached to the package.

5. The materials tracker of claim 4, wherein the location tracking circuitry is configured to provide real-time location data at programmable intervals during shipment.

6. The materials tracker of claim 1, wherein the materials tracker is configured to detect arrival at a receiving address when the materials tracker is within a predetermined distance of the receiving address stored in a database and when the location data indicates the materials tracker is stationary, and to record a receipt time upon detection of arrival.

7. The materials tracker of claim 6, wherein the predetermined distance is approximately fifty meters.

8. The materials tracker of claim 1, wherein the materials tracker is configured to record an administration time when the materials tracker is removed from the package without requiring a button press.

9. The materials tracker of claim 1, wherein the materials tracker includes a conductive tape configured to be torn by a user to activate the battery to power the location tracking circuitry.

10. The materials tracker of claim 1, wherein the materials tracker is disposable and configured for single-use applications.

11. The materials tracker of claim 10, wherein the materials tracker is configured for tracking radioactive materials.

12. A method of tracking materials, comprising:
providing a materials tracker having an adhesive base covered by a peel-off layer, a flexible printed circuit board, a battery, and location tracking circuitry
removing the peel-off layer from the materials tracker, wherein removal of the peel-off layer activates the battery to power the location tracking circuitry by breaking an electrical connection;
attaching the materials tracker to a package via the adhesive base;
recording, by the location tracking circuitry, a first location of the package in response to the attachment of the materials tracker to the package;
recording, by the location tracking circuitry, a second location of the package in response to a delivery of the package to a delivery address;
removing the materials tracker from the package, wherein removal causes a metal element to remain adhered to the package and break a connection between a pair of terminals; and
recording an administration time in response to a breaking of the connection between the pair of terminals.

13. The method of claim 12, further comprising recording location data of the package periodically during shipment.

14. The method of claim 12, wherein detecting arrival at the receiving address comprises determining that the materials tracker is within a predetermined distance of the receiving address and that a location of the materials tracker is not changing.

15. The method of claim 14, wherein the predetermined distance is approximately fifty meters.

16. The method of claim 12, wherein the package contains radioactive material.

17. A circuit activation mechanism for a tracking device, comprising:
a power management unit having an enable pin, wherein the power management unit is coupled between a battery and a location tracking circuit;
a removable conductive element connecting the enable pin to the battery to maintain the power management unit in an operational state; and
an adhesive layer mechanically coupled to the removable conductive element, wherein physical removal of the adhesive layer from a package disconnects the removable conductive element from the enable pin to transition the power management unit to a non-operational state.

18. The tracking device of claim 17, wherein the removable conductive element is a wire connecting the enable pin to the battery.

19. The tracking device of claim 17, further comprising:
an accelerometer, wherein the tracking device is configured to record an acceleration above a threshold level and to report the acceleration through a cellular link to a server.
